(19) United States
(12) Patent Application Publication
(10) Pub. No.: US 2018/0243863 A1
(43) Pub. Date: Aug. 30, 2018

(54) METHOD FOR PRODUCING A COMPONENT STRUCTURE WITH IMPROVED JOINT PROPERTIES, AND COMPONENT STRUCTURE

(71) Applicants: THYSSENKRUPP STEEL EUROPE AG, Duisburg (DE); thyssenkrupp AG, Essen (DE)

(72) Inventors: Stefan MYSLOWICKI, Mönchengladbach (DE); David PIERONEK, Dortmund (DE)

(73) Assignees: THYSSENKRUPP STEEL EUROPE AG, Duisburg (DE); thyssenkrupp AG, Essen (DE)

(21) Appl. No.: 15/754,490

(22) PCT Filed: Aug. 17, 2016
(86) PCT No.: PCT/EP2016/069460

§ 371 Date: Feb. 22, 2018

(30) Foreign Application Priority Data
Sep. 7, 2015 (DE) 10 2015 114 989.3

(51) Int. Cl. B23K 35/02; B23K 35/30; B32B 15/01

(52) U.S. Cl. CPC B23K 35/0238; B23K 35/0272; B23K 35/306; B32B 15/011; B23K 35/3073; B23K 35/3086; B23K 35/3093; B23K 35/3066

(57) ABSTRACT

A method for producing a component structure from a first component and a second component may involve connecting the first component to the second component by way of a thermal joining process. The component structure has good crash properties, has good vibration resistance, has a lightweight construction, and is produced cost-effectively at least in part because the first component being a steel composite structure comprising a softer layer and a more-rigid layer. The softer layer may have a lower material strength and a higher deformability than the more-rigid layer. A part of a joint zone that is located in the first component may be formed at least partially in the relatively soft layer.

The present invention relates to a method for producing a component structure from a first component and at least one further component, wherein the first component is connected to the further component by means of a thermal joining process. In addition, the invention relates to a component structure, in particular a vehicle structure or a part thereof, for a motor vehicle or utility vehicle.

Methods for joining individual components to form a component structure for different materials and material combinations are known from the prior art. In particular, joined components for motor vehicles are subject nowadays to a particularly high degree of pressure to have lightweight construction, in order to meet the continuously increasing requirements in terms of fuel consumption, CO₂ emissions and crash safety given the simultaneous scarcity of the existing resources and the economic boundary conditions. For this reason, there has been for years a trend toward the use of steels with ever higher strength.

For example, in the field of automobiles and utility vehicles hot formed components are being used in order to achieve a high level of freedom in terms of the geometry of the components with high material strength of over 1500 MPa. In this way it is possible to allow for stringent requirements which are made in terms of lightweight construction.

For example, German laid-open patent application DE 10 2008 022 709 A1 describes the use of a multi-layer roll clad material composite in a vehicle structure, wherein three layers are produced from a steel alloy. In this context, the middle layer is to be composed of a steel alloy which can be formed satisfactorily, while the outer layers are to be composed of a high or super high strength steel alloy.

However, the high material strength can often not be converted directly into increased performance of the structure, since the connection technology, for example in the case of welding methods such as resistance spot welding, constitutes a limiting factor. It has, in fact, been shown that in the case of ultra high strength steels and hot forming steels with strength values above 1000 MPa after the welding, that is to say after the inputting of heat and subsequent cooling, a softening zone occurs, as a result of tempering effects, in the surroundings of the connection (heat-affected zone) which has a low strength and at the same time low ductility and therefore often serves as a starting point for cracks (“crack starter”) when crash loading occurs. However, this can have wide ranging consequences since the crack can extend from the connection zone into the component and therefore lead to the total loss of the integrity of the structure. This adversely affects, in particular, the crash properties and/or vibration resistance of the components. Corresponding investigations have been carried out within the scope of the FOSTA research project, P806 “Charakterisierung and Ersatzmodellierung des Bruchverhaltens von Punktschweißverbindungen an ultrahochfesten Stählen für die Crashsimulation unter Berücksichtigung der Auswirkung der Verbindung auf das Bauteilverhalten” [“Characterization and analogous modeling of the fracture behavior of spot-welding joints on ultra high strength steels for the simulation of crashes taking into account the effect of the joint on the component behavior”].

This behavior of a structure must, as can be expected, be strictly avoided. This problem can be countered, for example, by virtue of the fact that a selective heat treatment of the component flanges which are provided for the joint or by means of a subsequent heat treatment is carried out within the scope of partial press hardening.

It is alternatively conceivable to counter the problem structurally and to configure critical regions in an over-dimensioned fashion, that is to say, for example, to provide relatively wide component flanges or to vary the position of the welding spots or the number thereof.

These described approaches at any rate give rise to additional costs and/or additional weight owing to the relatively complex production method (for example as a result of relatively complex tools, controllers etc.) or the over-dimensioning, and therefore are opposed to the objective of a cost-effective lightweight construction.

Against this background, the object arises of specifying a method of the generic type and a component structure in which good crash properties and/or vibration properties can be achieved for the lightweight construction with cost-effective production.

The object is achieved according to a first teaching of the invention with a method of the generic type in that the first component is a steel material composite which comprises at least one relatively soft layer and one relatively rigid layer, wherein the relatively soft layer has a lower material strength and a higher deformability than the relatively rigid layer, and wherein the part of the joint zone which is located in the first component is formed at least partially in the relatively soft layer.

According to the invention it has been recognized that the connection strength, and associated with that in particular the crash properties and/or vibration resistance of the component structure, can be improved if a steel material composite is used which is joined in such a way that the joint zone is formed at least partially in the relatively soft layer which has a higher deformability and connection strength compared to the relatively rigid layer. It has in fact become apparent that the forces which can be transmitted with the component structure can increase significantly if the joint zone is formed at least partially in a relatively soft layer, since the cracks as a rule start from the surface of the facing materials which are joined to one another. In addition, the multiple embodiment of the joint zone in the relatively soft layer avoids the formation of a softening zone in the region of the joint zone which is critical in terms of loading, or around the joint zone compared to a monolithic solution with the material of the relatively rigid layer. As a result, forces are at least partially firstly transmitted to the layer with the relatively high deformability, and can then be transmitted from there in a planar fashion to the relatively rigid layer.

A steel material composite is understood to be a material composite which has at least one layer, in particular the relatively soft and/or relatively rigid layer, made of steel. A plurality of layers, or all the layers, of the steel material composite are preferably formed from a steel.

The steel material composite can also have more than two layers. In particular, the steel material composite can have, for example, a plurality of relatively soft layers (for example two or three). The steel material composite can also have a plurality of relatively rigid layers (for example two or three). In this case, all the relatively soft layers preferably have a higher deformability than the relatively rigid layers. In particular, in this case the part of the joint zone which is located in the first component can be formed at least partially in at least one of the relatively soft layers. However, it is also possible for the joint zone to be formed at least partially in a plurality of the relatively soft layers (for example two thereof).

The further component can be embodied, for example, as a monolithic component or can also be produced from a steel material composite. In particular, the further component can be constructed like the first component. In this respect, the statements that have been made herein with respect to the first component also apply to the further component.

The fact that the relatively soft layer has a lower material strength and higher deformability than the relatively rigid layer means, in particular, that the relatively soft layer has a higher ductility, a relatively high elongation at brake, a relatively low tensile strength and/or a lower hardness compared to the relatively rigid layer, in particular in the hot formed state. In addition, the relatively soft layer is preferably distinguished by means of good suitability of welding and/or sufficient connection strength of the weld.

The joint zone is understood as meaning, in particular, the region which is affected by a materially joined connection of the components, for example a weld nugget. The weld nugget is surrounded by a heat-affected zone in which the structural properties of the steels have been changed. In the case of steels with strength levels of over 1000 MPa, in particular heat formed or press hardened steels, the critical softening zone is formed in the region of the heat-affected zone.

According to one refinement of the method according to the invention, the outer layer of the first component which faces the further component is a relatively soft layer. As a result, it can easily be ensured that the joint zone is located at least partially in the relatively soft layer of the first component and, in addition, the relatively soft layer can be positioned near to the joint zone. This can result in an effective improvement in the mechanical properties of the component structure. The relatively soft layer of the first component can make direct contact with the further component at least in certain areas (for example at least in the region to be joined).

It is possible for the part of the joint zone which is located in the first component to be for the most part or even exclusively located in the relatively soft layer. Therefore, stress peaks owing to mechanical loading can be satisfactorily absorbed by the relatively soft layer. In the optimum case, the softening zone in the relatively rigid layer is therefore not critical in terms of failure.

According to a further refinement of the method according to the invention, the part of the joint zone which is located in the first component extends over a plurality of layers of the first component. As a result, an optimum of properties of the joint connection and of the crash performance and/or of the vibration resistance can be achieved if the joint zone extends over a plurality of layers (for example over two, three or more).

According to a further refinement of the method according to the invention, the relatively soft layer is composed, for example of a deep-drawing steel, IF steel or micro-alloyed steel, and the relatively rigid layer is composed of a super high strength or ultra high strength steel, in particular a steel with a martensite structure, preferably manganese-boron steel. It has become apparent that the use of a (hot formable) manganese-boron steel can, depending on the alloy composition, permit a material composite for a particularly favorable component structure to be formed.

The further component or layers thereof can also be composed of a manganese-boron steel.

According to one refinement, at least one layer of the first component is composed of a deep-drawing steel, an IF steel, a micro-alloyed steel, a dual phase steel, a complex phase steel or a martensite phase steel. According to a further refinement, at least one layer of the first component is composed of a steel alloy with good corrosion protection properties. The same applies to refinements of the further component. Furthermore, the first and/or the further component can have a metallic and/or organic coating on one side or on both sides.

According to a further refinement of the method according to the invention, the relatively soft layer has in the state of use an elongation at brake A₈₀ of at least 10%, preferably at least 14%, particularly preferably at least 17%. In the case of such elongation at brake values the relatively soft layer has a correspondingly high deformability. It has become apparent that such minimum elongations at brake of the relatively soft layer have a positive effect on the performance of the component structure after the joining. As already stated, the first component can also have further layers for which such properties are advantageous. The state of use is, in particular, the hardened state.

The relatively rigid layer preferably has an elongation at brake A₈₀ which is less than the elongation at brake of the relatively soft layer. As a result, the strength of the first component can be improved. However, the elongation at brake A₈₀ of the relatively rigid layer is at least 3%, preferably at least 5%.

According to a further refinement of the method according to the invention, the C content of the relatively soft layer is at maximum 0.25% by weight, preferably at maximum 0.15% by weight and particularly preferably at maximum 0.1% by weight. As a result, the deformability and suitability for welding and the bonding strength of the relatively soft layer can be kept high, which has a positive effect on the crash performance and/or vibration resistance of the component structure.

For example, the relatively soft layer is composed of a steel alloy having the following alloy components in % by weight:
C<0.10
Si<0.35
Mn<1.00
P<0.030
S<0.025
Al>0.06
Nb<0.10
Ti<0.15
Cr<0.2
Cu<0.20
Mo<0.05
N<0.007
Ni<0.20
Residual iron and unavoidable impurities.

For example, the relatively rigid layer is composed of a manganese-boron steel having the following alloy components in % by weight:
C<0.60
Si<0.40
Mn<1.40
P<0.025
S<0.010
Al>0.06
Ti<0.05
Cr+Mo<0.5
B<0.005
N<0.008
Ni<0.20
Nb<0.005
V<0.02
Sn<0.05
Ca<0.006
As<0.02
Co<0.02
Residual iron and unavoidable impurities.

The relatively rigid layer is composed, for example, of a steel whose C content is at maximum 0.40% by weight and preferably at maximum 0.30% by weight. For example, the C content of the relatively rigid layer is higher than that of the relatively soft layer. That is to say the C content of the relatively rigid layer is, for example at least 0.1% by weight, and preferably at least 0.15% by weight. This improves the strength of the component.

According to a further refinement of the method according to the invention, the relatively soft layer has in the state of use a tensile strength Rₘ of at maximum 1000 MPa, preferably at maximum 800 MPa, particularly preferably at maximum 600 MPa and/or the relatively rigid layer has in the state of use a tensile strength Rₘ of at least 700 MPa, preferably at least 900 MPa and particularly preferably at least 1000 MPa. It has become apparent that such a maximum limitation of the tensile strength in the relatively soft layer keeps the deformability high and therefore improves the joining properties of the first component. At the same time, the strength of the first component can be increased if the relatively rigid layer has the specified minimum tensile strength values.

According to a further refinement of the method according to the invention, the thermal joining is welding, in particular resistance spot welding, and the joint zone is a weld nugget or an MAG weld. Welding is a frequently used method for joining individual components to form a structure, in particular in the field of automobiles. It has become apparent that, in particular, welding methods such as also MAG welding benefit from the proposed method. However, it is also possible to implement the thermal joint by means of soldering, for example light arc soldering.

According to a further refinement of the method according to the invention, the starting material for generating the first component is produced by roll cladding, in particular hot roll cladding or by means of a casting method. In this way, the layers of the first component can be easily connected to one another. A connection of the layers by means of, for example, a casting method is also conceivable.

According to a further refinement of the method according to the invention, the first and/or the second component is hot formed, in particular press hardened, before the joining. By means of hot forming or press hardening of the components, particularly lightweight and stable component structures which are suitable for lightweight construction can be made available. It is advantageously possible to dispense with taking particular precautions in the region of the joint connection during press hardening, which makes the forming of the component simpler and more cost-effective. However, it is basically also conceivable for the first and/or second component to be cold formed or semi-warm formed. Combinations of these forming methods are also possible.

The first and/or second component can be formed, for example, by pressure forming, tensile forming, tensile compressive forming, flexural forming or shear forming.

According to a further refinement of the method according to the invention, the first component has an asymmetrical or symmetrical design of the layers, in particular with respect to the thickness and/or the material of the layers. As a result, the design of the first component can be adapted in an optimum way to the joining to be carried out. For example, the relatively rigid layer or further layers can be embodied to be correspondingly thin with the same or similar properties on the side of the first component facing the further component, and can be embodied to be, for example, thinner than on the side of the first component facing away from the further component. As a result, a relatively large part of the relatively soft layer or further layers can overlap with the same or similar properties with the joint zone. However, the design can also be symmetrical.

The thickness of the first and/or second component is preferably between 0.5 mm and 6 mm, and more preferably between 1 mm and 4 mm. The thickness of the relatively soft layer depends, in particular, on the total number of layers. If, for example, just one relatively soft and one relatively rigid layer are provided, the relatively soft layer can constitute, for example, 10% to 90%, in particular 20% to 80%, preferably 40% to 60% of the total thickness of the first component. In addition to the motor vehicle, variants for utility vehicles (incl. trailers), for example parts of frame structures which can have substantially larger component thicknesses are also conceivable.

According to a further refinement of the method according to the invention, the first component is constructed from two, three, four or more layers. In the case of multi-layer structures of the first component, the component properties can be set to be more homogenous over the thickness as the number of layers increases. In the case of structures of the first component with three or more layers, a plurality of layers made of the same material as the relatively soft layer and/or as the relatively rigid layer are preferably provided. The part of the joint zone which is located in the first component is preferably constructed for the most part in relatively soft layers.

According to a further refinement of the method according to the invention, the component structure is a component of a vehicle, in particular of a motor vehicle or utility vehicle, or of a part thereof.

For example, the component structure or at least one of the components is a vehicle bodywork, a chassis, a set of running gear or a part thereof. The bodywork is, for example, self-supporting and is preferably predominantly constructed in a shell design. For example the bodywork is a skeleton bodywork (for example based on the space frame design) or part of a utility vehicle structure. For example, the component structure or at least one of the components is a structure part or an outer skin part of a vehicle. For example, the component structure or at least one of the components is handlebars, an axle, a crash part, a gusset plate, a guide part, a carrier, in particular a longitudinal carrier or a transverse carrier, a reinforcement part, a profile, a hollow profile, a bar, a strut, a pillar, in particular an A, B, C or D pillar, a frame, a tunnel, a sill, a floor panel, a suspension strut dome, an end wall, a side impact carrier, a bumper, a mudguard, a wheel house component or a sheet metal component, in particular a door panel, an engine hood panel or a roof panel or a part thereof.

According to a second teaching of the present invention, the object which is specified at the beginning is also achieved by a component structure, in particular a vehicle structure or a part thereof for a motor vehicle or utility vehicle, which component structure is produced according to a method according to the invention.

The component structure therefore has a first component and a further component which are connected by means of a thermal joining process. In this context, the first component is a steel material composite which comprises at least one relatively soft layer and one relatively rigid layer. The relatively soft layer has a higher deformability than the relatively rigid layer, and the part of the joint zone which is located in the first component is at least partially formed in the relatively soft layer.

As already stated at the beginning, it has been recognized that the joining behavior and therefore, in particular, the crash properties and/or vibration resistance values of such a component structure can be improved. As a result, specifically the formation of a softening zone which serves as crack starter in regions of the connection which are critical in terms of loading can be reduced or prevented.

With respect to further advantageous refinements of the component structure, reference is made to the method according to the invention and the advantages thereof. The described method and the refinements thereof are intended also to disclose, in particular, the component structure produced therewith.

The invention will be explained in more detail in the text which follows on the basis of advantageous exemplary embodiments and in conjunction with the drawing, in which:

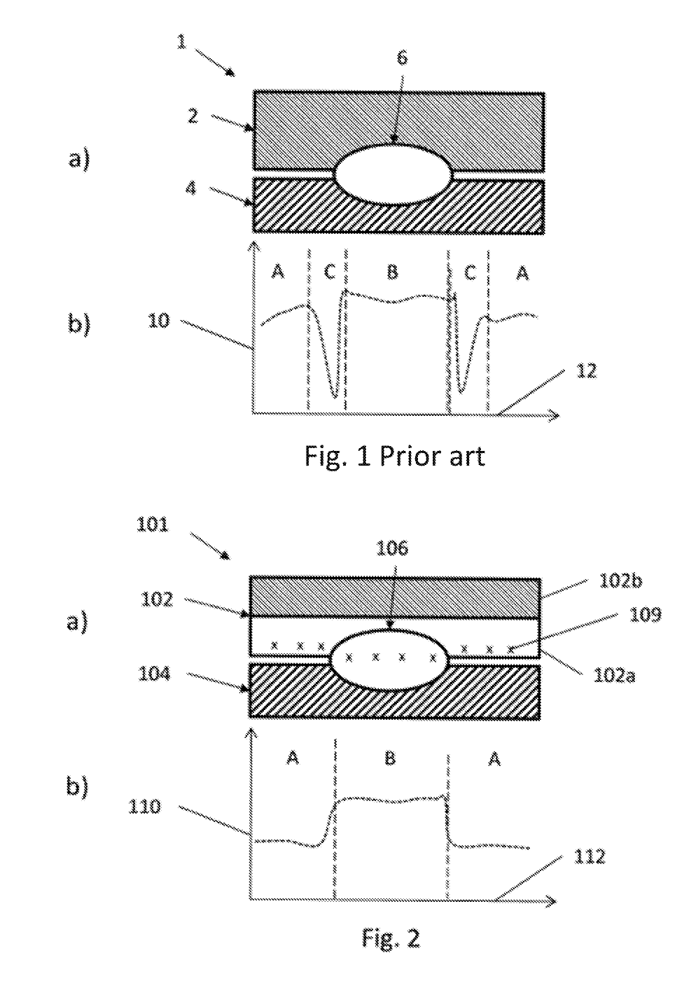

FIGS. 1a,b show a cross-sectional view of a component structure according to the prior art and a hardness profile in the form of a sketch;

FIG. 2 shows a cross-sectional view of a first exemplary embodiment of a component structure according to the invention and a hardness profile in the form of a sketch;

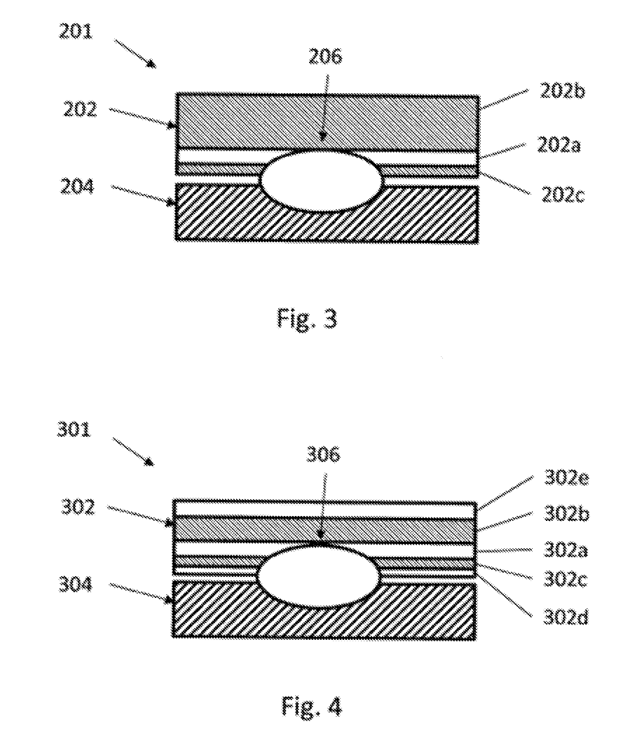

FIG. 3 shows a cross-sectional view of a second exemplary embodiment of a component structure according to the invention; and

FIG. 4 shows a cross-sectional view of a third exemplary embodiment of a component structure according to the invention.

FIG. 1a firstly shows a cross-sectional view of a component structure according to the prior art. The component structure 1 comprises a first component 2 and a further component 4. The component 2 is, for example, press hardened and has a tensile strength of 1500 MPa. The component 2 has been joined to the further component 4 by means of resistance spot welding. This results in a weld nugget 6.

FIG. 1b shows in sketch form the hardness profile 8 in the region of the weld nugget 6 (illustrated in FIG. 1a) along the measuring points 9. For this purpose, the hardness has been plotted on the axis 10 against the position along the cross section on the axis 12. It is apparent that the component structure 1 has a high level of hardness far outside the weld nugget 6 (region A) owing to the material property of the first component 2 and in the interior of the weld nugget 6 (region B). However, in the edge region or junction region of the weld nugget 6 (region C) there arises a softening zone with a local drop in the hardness. Here, crack starters form, as a result of which this region is the starting point for failure of a material in the case of loading, in particular in the case of high loading such as, for example, in the case of a crash.

FIG. 2a shows a cross-sectional view of a first exemplary embodiment of a component structure 101 according to the invention, which component structure 101 has been produced with an exemplary embodiment of the method according to the invention. The component structure 101 comprises a steel material composite as a first component 102 and a further component 104 which have been joined by means of resistance spot welding. The first component 102 comprises a relatively soft layer 102a and a relatively rigid layer 102b, wherein the relatively soft layer 102a has a higher deformability than the relatively rigid layer 102b. The relatively soft and the relatively rigid layers 102a, 102b are joined to one another in a materially joined fashion, for example by hot roll cladding. The relatively soft layer 102a is here an outer layer of the first component 102 facing the further component 104.

The relatively soft layer 102a is produced in this case from the material MBW 500 and has in the state of use (after austenitizing at 920° C. and subsequent hot forming and press hardening) a yield strength R_{p 0.2} of 400 MPa, a tensile strength Rₘ of 550 MPa and an elongation at brake A₈₀ of at least 17%. The relatively rigid layer 102b is produced in this case from the material MBW 1500 and has in the state of use or press-hardened state a yield strength R_{p 0.2} of 1000 MPa, a tensile strength Rₘ of 1500 MPa and an elongation at brake A₈₀ of at least 5%. The portions of the relatively soft and relatively rigid layers 102a, 102b are each here approximately 50% of the thickness of the first component 102. Overall, the first component has approximately a tensile strength of 1000 MPa. The further component 104 is in this case a monolithic component made of a steel material. The part of the weld nugget 106 located in the first component has been constructed exclusively in the relatively soft layer 102a in this case.

FIG. 2b shows in sketch form the hardness profile 108 in the region of the weld nugget 106 (illustrated in FIG. 2a) along the measuring points 109. For this purpose, the hardness has in turn been plotted on the axis 110 against the position on the axis 112. It is to be noted that the component structure has a lower hardness far outside the weld nugget 106 (region A) than in the interior of the weld nugget 106 (region B) owing to the relatively high deformability of the relatively soft layer 102a. However, in the edge region of the weld nugget 106 a softening zone with local drop in the hardness is not brought about. As a result, crack starters as a starting point for failure of a material can be avoided or reduced.

FIG. 3 shows a cross-sectional view of a second exemplary embodiment of a component structure 201 according to the invention which is similar to the exemplary embodiment shown in FIG. 2. In contrast to the first component 102 from FIG. 2, the first component 202 is constructed with three layers and has, in addition to the layers 202a, 202b formed before, in addition a (second) relatively rigid layer 202c. The layer 202c is composed of the same material as the relatively rigid layer 202b. The relatively soft layer 202a is formed here lying on the inside. The relatively rigid layer 202c facing the further component 204 is, however, constructed so as to be thinner than the relatively rigid layer 202b facing away from the further component 204. Owing to this asymmetrical design of the first component 202 with respect to the thicknesses of the layers, the relatively soft layer 202a is again arranged in such a way that the part of the weld nugget 206 located in the first component 202 is constructed partially in the relatively soft layer 202a.

FIG. 4 shows a cross-sectional view of a third exemplary embodiment of a component structure 302 according to the invention which is similar to the exemplary embodiment shown in FIG. 3. In contrast to the first component 202 from FIG. 3, the first component 302 is constructed with five layers and has, in addition to the layers 302a, 302b, 302c formed before, in addition two further relatively soft outer layers 302d, 302e. The relatively soft layers 302d, 302e are composed of the same material as the relatively soft layer 302a and are therefore more deformable than the relatively rigid layers 302b, 302c. The layers are also of asymmetrical design here with respect to their thickness, wherein, in particular, the relatively rigid layer 302c is thinner than the relatively rigid layer 302b. As a result, it is in turn ensured that the relatively soft layers 302a, 302d are arranged in such a way that a largest possible part of the part of the weld nugget 306 located in the first component 302 is constructed in two of the three relatively soft layers 302a, 302d.

1.-14. (canceled)

15. A method for producing a component structure from a first component and a second component, the method comprising connecting the first component to the second component at a joint zone by way of a thermal joining process, wherein the first component is a steel composite structure that includes a softer layer and a more-rigid layer, with the softer layer having a lower material strength and a higher deformability than the more-rigid layer, wherein a part of the joint zone located in the first component is formed at least partially in the softer layer.

16. The method of claim 15 wherein an outer layer of the first component that faces the second component is the softer layer.

17. The method of claim 15 wherein the part of the joint zone located in the first component extends over a plurality of layers of the first component.

18. The method of claim 15 wherein the softer layer comprises a deep-drawing steel, an interstitial-free steel, or a micro-alloyed steel, wherein the more-rigid layer comprises a super high strength steel or an ultra high strength steel.

19. The method of claim 15 wherein the more-rigid layer comprises manganese-boron steel with a martensite structure.

20. The method of claim 15 wherein in a state of use the softer layer has an elongation at brake A₈₀ of at least 10%.

21. The method of claim 15 wherein in a state of use the softer layer has an elongation at brake A₈₀ of at least 17%.

22. The method of claim 15 wherein a carbon content of the softer layer is at most 0.25% by weight.

23. The method of claim 15 wherein a carbon content of the softer layer is at most 0.1% by weight.

24. The method of claim 15 wherein at least one of:
in a state of use the softer layer has a tensile strength Rₘ of at most 1000 MPa; or
in a state of use the more-rigid layer has a tensile strength Rₘ of at least 700 MPa.

25. The method of claim 15 wherein
in a state of use the softer layer has a tensile strength Rₘ of at most 600 MPa; and
in a state of use the more-rigid layer has a tensile strength Rₘ of at least 1000 MPa.

26. The method of claim 15 wherein the thermal joining process comprises welding, wherein the joint zone is a weld nugget or an MAG weld.

27. The method of claim 15 wherein the thermal joining process comprises resistance spot welding.

28. The method of claim 15 comprising producing a starting material for generating the first component by roll cladding or casting.

29. The method of claim 15 comprising hot forming at least one of the first component or the second component before connecting the first and second components.

30. The method of claim 15 comprising press hardening at least one of the first component or the second component before connecting the first and second components.

31. The method of claim 15 wherein the first component has a symmetrical configuration of the softer and the more-rigid layers with respect to at least one of thickness or material of the softer and the more-rigid layers.

32. The method of claim 15 wherein the first component has an asymmetrical configuration of the softer and the more-rigid layers with respect to at least one of thickness or material of the softer and the more-rigid layers.

33. The method of claim 15 wherein the first component further comprises at least a third layer.

34. A component structure for a vehicle that is produced according to the method of claim 15.
